(19) United States
(12) Patent Application Publication
(10) Pub. No.: US 2026/0116047 A1
(43) Pub. Date: Apr. 30, 2026

(54) LIGHTWEIGHT GYPSUM BOARD

(71) Applicant: GEORGIA-PACIFIC GYPSUM LLC, Atlanta, GA (US)

(72) Inventors: Richard David Jordan, Decatur, GA (US); Hamed Mustafa Kayello, Peachtree Corners, GA (US); Sudhanshu Srivastava, Decatur, GA (US); Vincent B. Thomas, Bogart, GA (US)

(21) Appl. No.: 19/115,800

(22) PCT Filed: Oct. 12, 2023
(86) PCT No.: PCT/IB2023/060287

§ 371 Date: Mar. 27, 2025

Related U.S. Application Data
(60) Provisional application No. 63/417,718, filed on Oct. 20, 2022.

(51) Int. Cl. B32B 13/14; B32B 5/02; B32B 13/02; E04C 2/04

(52) U.S. Cl. CPC B32B 13/14; B32B 5/028; B32B 13/02; E04C 2/043; B32B 2250/03; B32B 2250/40; B32B 2260/021; B32B 2260/044; B32B 2262/0253; B32B 2262/0261; B32B 2262/101; B32B 2264/2031; B32B 2307/7376; B32B 2607/00

(57) ABSTRACT

Systems and methods for manufacturing a lightweight gypsum board are provided. The lightweight gypsum board includes a gypsum layer formed from a gypsum slurry, where the gypsum layer has a bottom and a top. The gypsum slurry includes polymat and foam. The gypsum board further includes a first mat on the bottom of the gypsum layer and a second mat on the top of the gypsum layer.

### CROSS-REFERENCE TO RELATED APPLICATIONS

This application claims the benefit of U.S. Provisional Application No. 63/417,718, filed Oct. 20, 2022, and entitled “LIGHTWEIGHT GYPSUM BOARD,” which is incorporated by reference herein in its entirety.

### BACKGROUND

The present invention generally relates to the field of gypsum board products, and more specifically to a lightweight gypsum board having an extruded polymat reinforced core.

Typical building panels, such as building sheathing or roof panels, include a core material, such as gypsum, and a mat facer, such as a fiberglass mat facer. During manufacturing, the gypsum core material is traditionally applied as a slurry to a surface of the mat facer and allowed to set, such that the mat facer and gypsum core are adhered at the interface. Often, such panels suffer from water intrusion and other performance issues. Accordingly, it would be desirable to provide panels having improved water-resistive properties.

### BRIEF SUMMARY

In general, various embodiments of the present disclosure provide gypsum boards, methods of manufacturing, and/or the like.

According to one embodiment of the present disclosure, a lightweight gypsum board having an extruded polymat reinforced core is provided. The gypsum board includes a gypsum layer formed from a gypsum slurry, where the gypsum layer has a bottom and a top. The gypsum slurry includes polymath and foam. The gypsum board further includes a first mat on the bottom of the gypsum layer and a second mat on the top of the gypsum layer.

According to various embodiments, there is provided a gypsum board, having a gypsum layer formed from a gypsum slurry, the gypsum layer having a bottom and a top, the gypsum slurry containing a three-dimensional polymat of entangled fibers and foam; a first mat placed on the bottom of the gypsum layer; and a second mat placed on the top of the gypsum layer.

In some embodiments, the polymat has a thickness.

In some embodiments, the thickness is one of ⅜ inch, ¼ inch, ¾ inch, or ⅛ inch.

In some embodiments, the polymat has an extruded polymer.

In some embodiments, the polymat includes polypropylene, polyethylene, ABS, or polyamide such as nylon-6,6, nylon-6, or their blends.

In some embodiments, the gypsum board includes a glass mat.

In some embodiments, polymat is attached to the glass mat.

In some embodiments, the polymat is patterned on the glass mat according to a pattern.

In some embodiments, the pattern is one of lines, dots, or shapes.

In some embodiments, the polymat has a modified structure to further enhance physical strength properties of the gypsum board.

In some embodiments, the modified structure is accomplished by using rigid polymers, geometric shaping, or additional solid features.

In some embodiments, the polymat is attached to the first mat.

In some embodiments, the polymat is attached to the second mat.

In some embodiments, the polymat is attached to the first mat and the second mat.

In some embodiments, the polymat is made continuous.

In some embodiments, the polymat is patterned on the first mat.

In some embodiments, the polymat is patterned on the second mat.

In some embodiments, the polymat is patterned on the first mat and the second mat.

In some embodiments, the polymat is treated with corona or plasma to enhance adhesion to gypsum slurry.

According to yet another embodiment of the present disclosure, there is provided a method of manufacturing a lightweight gypsum board having an extruded polymat reinforced core is provided. The method includes forming a gypsum layer from a gypsum slurry, where the gypsum layer has a bottom and a top. The gypsum slurry includes polymat and foam. The method further includes positioning a first mat on the bottom of the gypsum layer and positioning a second mat on the top of the gypsum layer.

The above summary is provided merely for purposes of summarizing some example various embodiments to provide a basic understanding of some embodiments of the disclosure. Accordingly, it will be appreciated that the above-described various embodiments are merely examples. It will be appreciated that the scope of the disclosure encompasses many potential various embodiments in addition to those here summarized, some of which will be further described below.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a cross-sectional view of an example gypsum panel, according to various embodiments;

FIG. 2 is a cross-sectional view of an example gypsum panel, according to various embodiments;

FIG. 3 depicts example free-standing extruded polypropylene (e.g., polymat ⅜ inch), according to various embodiments;

FIG. 4 depicts free-standing extruded polypropylene (e.g., polymat ⅜ inch) introduced into the middle of a gypsum core, according to various embodiments;

FIGS. 5A and 5B depict adhesion of example polymat in a gypsum core with gypsum stucco and a first and second mat, according to various embodiments;

FIG. 6 depicts gypsum slurry being added with polymat between the first and second mats, according to various embodiments;

FIG. 7 is a chart depicting comparison of plate pull through test results, according to various embodiments; and

FIG. 8 is a chart depicting comparison of nail pull test results for boards having reinforced fibers, according to various embodiments.

### DETAILED DESCRIPTION

The invention is described in detail below with reference to the figures for purposes of illustration only. Modification to various embodiments illustrated within the spirit and scope of the present invention will be readily apparent to one of skill in the art.

Embodiments herein provide for gypsum boards or gypsum panels having reduced weight (e.g., by approximately 20% as compared to conventional gypsum boards or panels) without having a negative impact on other properties of the boards. In certain instances, the weight reduction realized may be in a range of approximately 10% to 30%; in others, approximately 15% to 25%.

Embodiments herein reduce the weight of gypsum panels or gypsum boards by incorporating an extruded three-dimensional polymer mat of entangled filaments (e.g., polyolefin based) in the gypsum core of the board to improve structural integrity. In embodiments, the polymat can be polypropylene based (e.g., ⅜ inch thick) and introduced either in the gypsum core or attached to the inside of a first mat on a first surface of a gypsum layer of the gypsum board or the inside of a second mat on a second surface of the gypsum layer.

Introducing the polymat with extra foam enables a reduction in board weight, and the mesh fibers of the polymat provide additional reinforcement to the gypsum core and the overall gypsum board. Embodiments herein achieved the approximate 20% weight reduction as well as an approximate 25% improvement in plate pull through values. In certain instances, the pull through values may range from approximately 15% to 30%.

In various embodiments, the polymat comprises different thicknesses (e.g., ⅜, ¼, ¾, ⅛ inches). The diameter of the extruded fiber can also be modulated from thick to thin fiber mesh sizes. Polymers which can be extruded are polypropylene, polyethylene, ABS, polyamides such as nylon-6,6, nylon-6, or their blends, and the like. Depending upon the crystallinity of the polyolefin, the polymat can also be made more brittle or flexible for easier cutting during board manufacture or “score and snap” with a razor knife during field installation.

In embodiments, attachment of the polymat to a glass mat of the gypsum board is mechanical and provides flexibility to create different patterns like continuous, lines, dots, and the like.

In embodiments, the polymat can further enhance the physical strength properties of the gypsum board, such as bending, stiffness, racking, shear, and fastener holding. This can be accomplished by changing the structure of the polymat, for example, by using more rigid polymers and/or geometric shaping. Fastener holding can be enhanced by adding solid features into polymat as well (e.g., bars or more dense areas along nailing areas) via different patterns.

In various embodiments, a gypsum core of a gypsum board or panel herein comprises a gypsum slurry with extra foam and polypropylene polymat (⅜ inch).

In various embodiments, a gypsum core of a gypsum board or panel herein comprises a gypsum slurry with extra foam and polypropylene polymat (¼ inch).

In various embodiments, a gypsum core of a gypsum board or panel herein comprises a gypsum slurry with extra foam and polypropylene polymat (⅛ inch).

In various embodiments, a gypsum core of a gypsum board or panel herein comprises a gypsum slurry with extra foam, and polypropylene polymat (⅜ inch) is attached to a first (e.g., face) mat of the gypsum board.

In various embodiments, a gypsum core of a gypsum board or panel herein comprises a gypsum slurry with extra foam, and polypropylene polymat (¼ inch) is attached to a first (e.g., face) mat of the gypsum board.

In various embodiments, a gypsum core of a gypsum board or panel herein comprises a gypsum slurry with extra foam, and polypropylene polymat (⅛ inch) is attached to a first (e.g., face) mat of the gypsum board.

In various embodiments, a gypsum core of a gypsum board or panel herein comprises a gypsum slurry with extra foam, and polypropylene polymat (⅜ inch) is attached to a second (e.g., back) mat of the gypsum board.

In various embodiments, a gypsum core of a gypsum board or panel herein comprises a gypsum slurry with extra foam, and polypropylene polymat (¼ inch) is attached to a second (e.g., back) mat of the gypsum board.

In various embodiments, a gypsum core of a gypsum board or panel herein comprises a gypsum slurry with extra foam, and polypropylene polymat (⅛ inch) is attached to a second (e.g., back) mat of the gypsum board.

In various embodiments, the polypropylene polymat in the aforementioned embodiments can instead be other polymers or polyethylene or can be used in combinations. For example, a face mat or side can include polypropylene polymat mesh and a back mat or side can include a different polymer-based mesh or in the core. By way of further example, the polypropylene or other polymat can be continuous on one side (e.g., the face mat or side, or the back mat or side) while being patterned on the other side.

In various embodiments, the polymat can be made continuous either attached to a glass mat of the gypsum board or in the gypsum core. In various embodiments, the polymat can be patterned as lines attached to the glass mat. In various embodiments, the polymat can be patterned as dots attached to the glass mat. In various embodiments, the polymat can be patterned as different shapes attached to the glass mat.

In various embodiments, the polymat can be attached or patterned on both the first (e.g., face) mat and second (e.g., back) mat.

Gypsum panels or boards may contain a set gypsum core sandwiched between two mats, one or both of which may be coated. The mat coating may be a substantially continuous barrier coating. As used herein, the term “substantially continuous barrier coating” refers to a coating material that is substantially uninterrupted over the surface of the mat.

During manufacturing, a gypsum slurry may be deposited on the uncoated surface of a facer material, such as a paper sheet or fiberglass mat (which may be pre-coated offline or online) and set to form a gypsum core of the panel. The gypsum slurry may penetrate some portion of the thickness of the fiberglass mat or adhere to a paper facing material by chemical bonding and provide a mechanical bond for the panel. The gypsum slurry may be provided in one or more layers, having the same or different compositions, including one or more slate coat layers. As used herein, the term “slate coat” refers to a gypsum slurry having a higher wet density than the remainder of the gypsum slurry that forms the gypsum core.

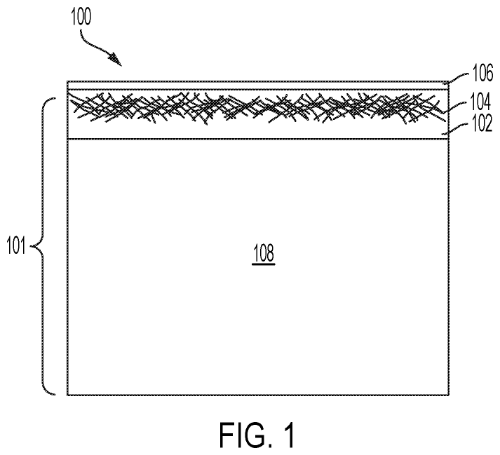

In certain embodiments, as shown in FIG. 1, a gypsum panel 100 includes a gypsum core 101 having a first surface and a second opposed surface, and a first facer material 104 (shown here as a fibrous mat) associated with the first surface of the gypsum core 101, such that gypsum of the gypsum core penetrates at least a portion of the first mat 104. The various layers are illustrated as separate layers in the figures for ease of illustration; however, it should be understood that overlap of these materials may occur at their interfaces. In certain embodiments, the gypsum panel 100 includes a set gypsum core 101 associated with a first surface of first fibrous mat 104 and an optional mat coating 106 applied to a second surface of the first fibrous mat 104.

In some embodiments, as shown in FIG. 1, the gypsum with hydrophobic additive (such as siloxane) of the gypsum core 101 penetrates a remaining portion of the first fibrous mat 104 such that voids in the mat 104 are substantially eliminated and the water resistance of the panel 100 is further enhanced. For example, in one embodiment, the first mat 104 has a mat coating 106 on a surface opposite the gypsum core 101, the mat coating 106 penetrating a portion of the first mat 104, to define the remaining portion of the first mat 104. That is, gypsum of the gypsum core 101 may penetrate a remaining fibrous portion of the first fibrous mat 104 such that voids in the first mat 104 are substantially eliminated. In certain embodiments, the mat 104 is a nonwoven fiberglass mat.

In certain embodiments, as shown in FIG. 1, the gypsum core 101 includes two or more gypsum layers 102, 108. For example, the gypsum core may include various gypsum layers having different compositions.

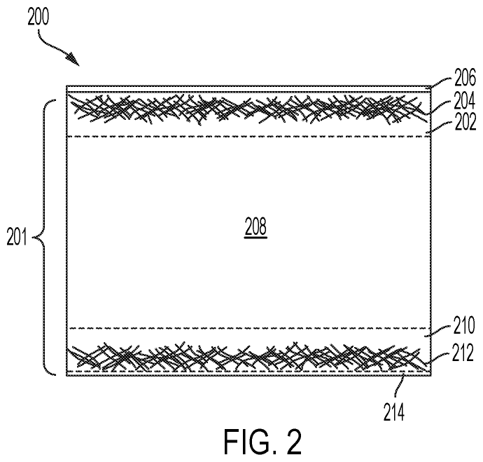

In certain embodiments, as shown in FIG. 2, a gypsum panel 200 includes two fibrous mats 204, 212 that are associated with the gypsum core 201. The second mat 212 is present on a face of the gypsum core 201 opposite the first mat 204. In some embodiments, only the first mat 204 has a mat coating 206 on a surface thereof. In other embodiments, both mats 204, 212 have a coating 206, 214 on a surface thereof opposite the gypsum core 201. In some embodiments, the gypsum core 201 includes three gypsum layers 202, 208, 210.

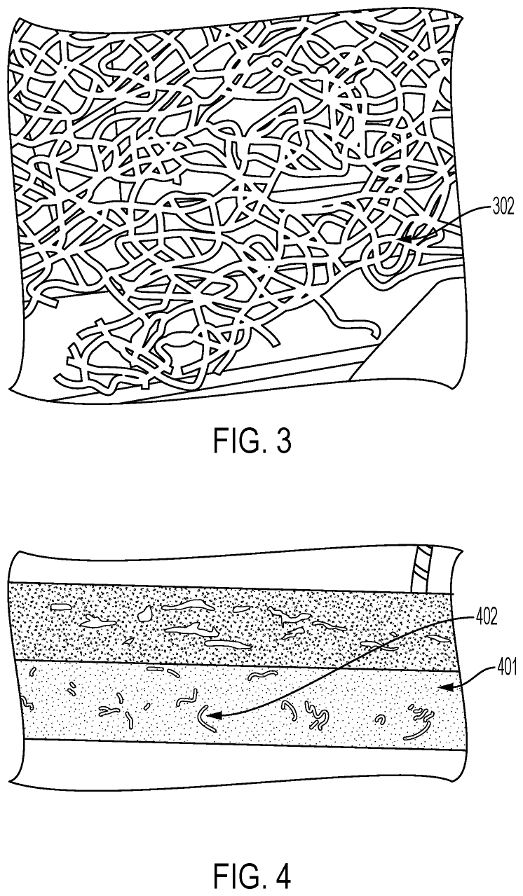

FIG. 3 depicts example free-standing extruded polypropylene 302 (e.g., polymat ⅜ inch), according to various embodiments. FIG. 4 depicts free-standing extruded polypropylene 402 (e.g., polymat ⅜ inch) introduced into the middle of a gypsum core 401, according to various embodiments.

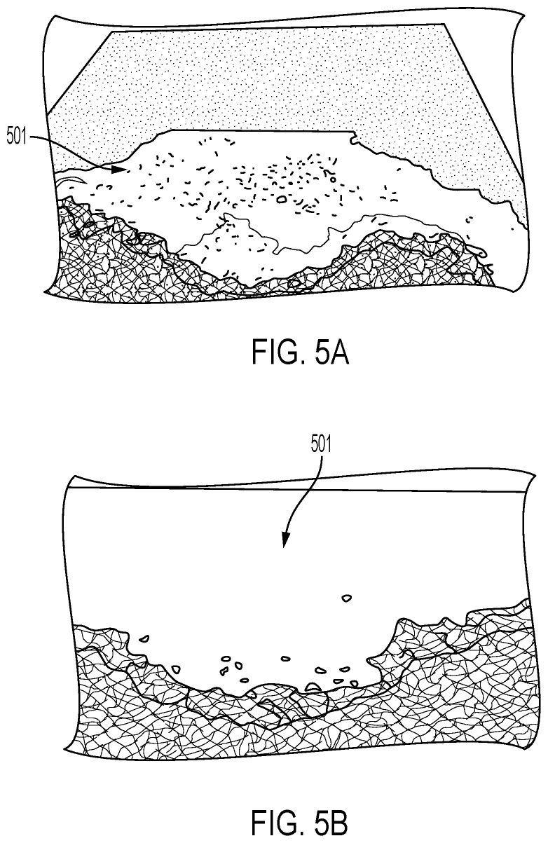

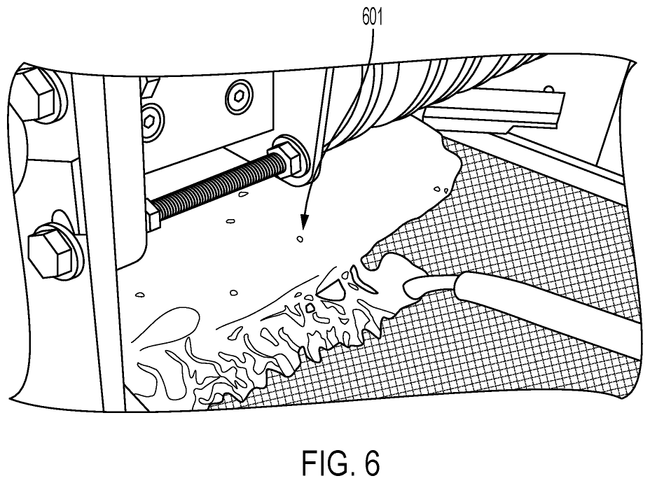

FIGS. 5A and 5B depict adhesion of example polymat in a gypsum core 501 with gypsum stucco and a first and second mat, according to various embodiments. Shown in FIGS. 5A and 5B, the polymat in the gypsum core showed excellent adhesion with the gypsum stucco and the face and back (e.g., first and second) mats. FIG. 6 depicts gypsum slurry 601 being added with polymat between the first and second mats, according to various embodiments.

### EXAMPLES

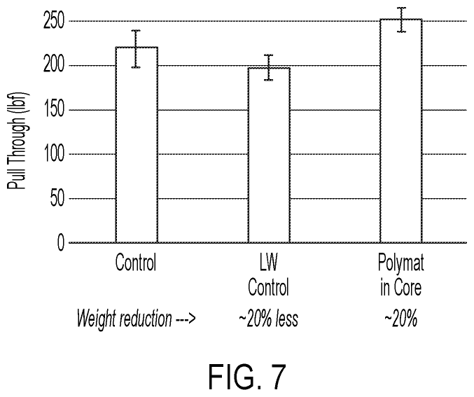

### Example 1—Pull Through Tests (Data Presented in FIG. 7)

FIG. 7 is a chart depicting comparison of plate pull through test results, according to various embodiments. For the data presented provided in FIG. 7, gypsum boards were prepared to compare their respective pull through strength characteristics. Control sample boards (e.g., Control in FIG. 7) and 20% lighter weight control sample boards (e.g., LW Control in FIG. 7) were prepared with gypsum slurry and glass mats on their respective face side and back side. A polymat sample board, in accordance with embodiments herein, included a ⅜-inch mesh incorporated in the core of the board with glass mats on the face side and back side. By controlling or adjusting the amount of foam added, the weight of the lighter weight LW control sample board and the polymat sample board (e.g., in the core of each board) was adjusted to achieve 20% lighter weight than the control sample boards.

For the pull through experiments depicted in FIG. 7, all of the samples were prepared with dimensions of 14″×14,″ and they were all subjected to a temperature of 70° F. for a duration of 24 hours at 50% humidity. A fastener was then inserted through each sample board, where the fastener holds a metallic disk on one side and the fastener is connected to an upper jaw of the testing machine on the other end. It is then confirmed that the clamp is aligned at a right angle to a square steel cradle holding the sample board. Once the board is confirmed to be properly fixed position, using the testing machine, the fastener is pulled up through the sample board. For each sample board and every test, the peak load and mode of failure is recorded.

Observed in FIG. 7, the board samples having polymat in the core showed improvement by ˜15% to 20% in the pull through experiments as compared to control samples (e.g., gypsum boards without polymat in the core, such as LW Control and Control in FIG. 7). Further, the board sample with polymat was ˜20% lighter as compared to the control board samples. The control with 20% lighter weight (e.g., LW Control in FIG. 7) did not perform well compared to a 2000 lbs/msf board (e.g., Control in FIG. 7). Thus, the incorporation of polymat reinforcing the core results in an improvement over a lighter control board as well.

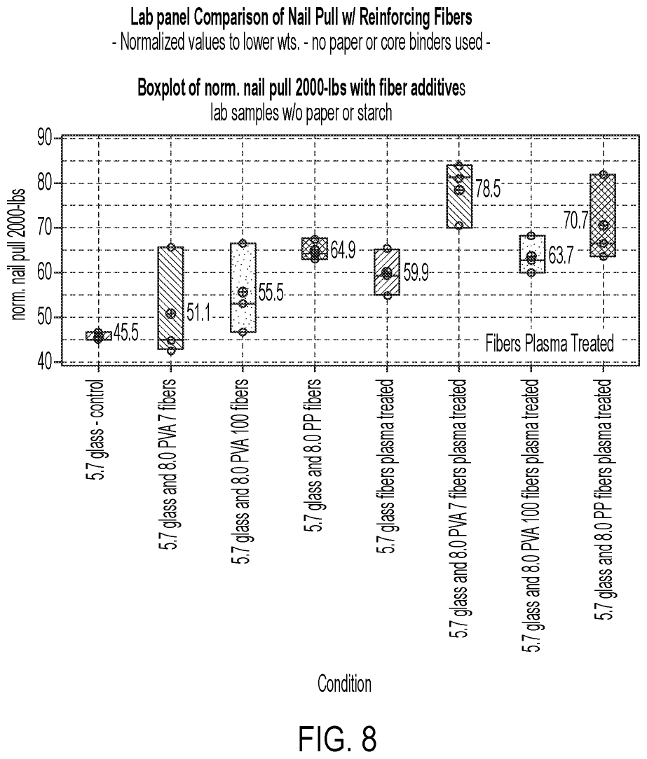

### Example 2—Nail Pull Tests (Data Presented in FIG. 8)

FIG. 8 is a chart depicting comparison of nail pull test results for boards having reinforced fibers, according to various embodiments. The nail pull test is conducted in accordance with the standard test methods for physical testing of gypsum panel products (e.g., ASTM-C473). The nail pull test is conducted by drilling a small pilot hole into the panel under inspection (e.g., a gypsum board). A nail shank attachment is then pushed into the pilot hole, thereby creating crack(s) in the gypsum board or panel; load is recorded until failure.

Introducing fibers or polymat into the core of the gypsum board or panel, in accordance with embodiments herein, may require better or improved distribution and better or improved interaction with gypsum molecules. Depending upon the fibers that are introduced, the fibers may be well distributed in the core such as hydrophilic fibers. Fiberglass, PVA and PP can be plasma treated (or corona treatments via bulk drum treater or treatment with surfactants) to improve the gypsum adhesion to fibers in the core thereby mitigating crack propagation. The increase in gypsum adhesion to fibers may increase the ability to prevent shear load related fracturing in the core which occurs in the nail pull test. As shown in FIG. 8, plasma treated fibers resulted in an improvement in nail pull values.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A gypsum board, comprising:
a gypsum layer formed from a gypsum slurry, the gypsum layer having a bottom and a top, the gypsum slurry containing a three-dimensional polymat of entangled fibers and foam;
a first mat placed on the bottom of the gypsum layer; and
a second mat placed on the top of the gypsum layer.

2. The gypsum board of claim 1, wherein the polymat comprises a thickness.

3. The gypsum board of claim 1, wherein the thickness is one of ⅜ inch, ¼ inch, ¾ inch, or ⅛ inch.

4. The gypsum board of claim 1, wherein the polymat comprises an extruded polymer.

5. The gypsum board of claim 1, wherein the polymat comprises polypropylene, polyethylene, ABS, or polyamide such as nylon-6,6, nylon-6, or their blends.

6. The gypsum board of claim 1, further comprising a glass mat.

7. The gypsum board of claim 6, wherein polymat is attached to the glass mat.

8. The gypsum board of claim 6, wherein the polymat is patterned on the glass mat according to a pattern.

9. The gypsum board of claim 8, wherein the pattern is one of lines, dots, or shapes.

10. The gypsum board of claim 1, wherein the polymat has a modified structure to further enhance physical strength properties of the gypsum board.

11. The gypsum board of claim 10, wherein the modified structure is accomplished by using rigid polymers, geometric shaping, or additional solid features.

12. The gypsum board of claim 1, wherein polymat is attached to the first mat.

13. The gypsum board of claim 1, wherein polymat is attached to the second mat.

14. The gypsum board of claim 1, wherein polymat is attached to the first mat and the second mat.

15. The gypsum board of claim 1, wherein the polymat is made continuous.

16. The gypsum board of claim 1, wherein polymat is patterned on the first mat.

17. The gypsum board of claim 1, wherein polymat is patterned on the second mat.

18. The gypsum board of claim 1, wherein polymat is patterned on the first mat and the second mat.

19. The gypsum board of claim 1, wherein the polymat is treated with corona or plasma to enhance adhesion to gypsum slurry.

20. A method for manufacturing a gypsum board, the method comprising:
forming a gypsum layer from a gypsum slurry, the gypsum layer having a bottom and a top, wherein the gypsum slurry comprises polymat and foam;
positioning a first mat on the bottom of the gypsum layer; and
positioning a second mat on the top of the gypsum layer.
